(19) United States
(12) Patent Application Publication
(10) Pub. No.: US 2020/0061750 A1
(43) Pub. Date: Feb. 27, 2020

(54) MITIGATING LOW SURFACE QUALITY

(71) Applicant: Coherent Munich GmbH & Co. KG, Gilching (DE)

(72) Inventors: Urs EPPELT, Fürstenfeldbruck (DE); Ludger MÜLLERS, München (DE); Anthony S. Lee, Petaluma, CA (US)

(73) Assignee: Coherent Munich GmbH & Co. KG, Gilching (DE)

(21) Appl. No.: 16/109,246

(22) Filed: Aug. 22, 2018

(51) Int. Cl. B23K 26/352; B23K 26/00; C03B 33/02

(52) U.S. Cl. CPC B23K 26/3576; C03B 33/0222; B23K 26/009; B23K 26/0006

(57) ABSTRACT

Methods and apparatuses are disclosed for laser processing. A method includes providing a laser beam transparent to a workpiece. A cover, having a surface quality better than the workpiece's surface, is provided and spaced apart from the workpiece's surface. A fluid is provided between and in contact with the cover and the workpiece's surface. A laser beam is directed through the cover and fluid to the workpiece. An apparatus includes a cover spaced apart from a workpiece's surface and including a surface quality better than the workpiece's surface, a fluid dispenser for introducing fluid between and in contact with the cover and the workpiece's surface, and a laser system that directs a laser beam through the cover and fluid to the workpiece.

### TECHNICAL FIELD

The present disclosure relates in general to processing materials using laser-radiation. The disclosure relates in particular to laser processing workpieces with low surface quality.

### BACKGROUND

Laser material-processing is increasingly used for cutting, drilling, marking, and scribing a wide range of materials, including brittle materials such as glass, ceramics, silicon, and sapphire. Traditional mechanical processing produces unwanted defects, such as micro-cracks that may propagate when the processed brittle material is stressed, thereby degrading and weakening the processed brittle material. Laser-processing of brittle materials using focused beams of laser-radiation produces precise cuts and holes, having high-quality edges and walls, while minimizing the formation of such unwanted defects. Progress in scientific research and manufacturing is leading to laser-processing of an increasing range of brittle materials, while demanding increased laser-processing speed and precision.

Transparent brittle materials interact with focused beams of pulsed laser-radiation through non-linear absorption of the laser-radiation. The pulsed laser-radiation may include a train of individual pulses, or rapid bursts of pulses. Each individual pulse or burst of pulses creates a defect in a workpiece of transparent brittle material at the focus of the beam. An article is cut from the workpiece by translating the focused beam to create a row of defects along a cutting line in the workpiece.

Often the row of defects just weakens the material along the cutting line. To fully separate the article from the rest of the workpiece requires an additional step of applying stress across the cutting line. Applying mechanical stress or thermal stress usually causes separation along the cutting line. Precise and controlled separation has been demonstrated using a laser-beam having a wavelength that is absorbed by the material and relatively high average power. The absorbed laser-power creates a thermal gradient across the cutting line, which causes cracks to propagate between the discrete defects produced by the pulsed laser-radiation, thereby forming a continuous break along the cutting line.

By way of example, a highly focused beam of ultra-short laser-pulses creates a self-guiding “filament” in a glass workpiece. To create a filament, a focused beam of pulsed laser-radiation having a sufficiently high intensity in a material becomes further focused due to non-linear components of the refractive index. Positive feedback between non-linear self-focusing and the high-intensity laser beam creates a plasma. A lower refractive index within the plasma and/or scattering of the focused beam by the plasma causes defocusing. A balance between the focusing and the defocusing sustains the plasma within a filament, which propagates through the glass workpiece and has a diameter much smaller than a diffraction-limited diameter of the focused beam of pulsed laser-radiation.

Propagation of such a filament creates a long slender defect through the workpiece in the form of a void, micro-cracking, or other material modifications. A row of defects is created by translating the focused ultra-short pulsed laser-beam along the cutting line. A carbon dioxide (CO₂) laser having wavelengths of around 10 micrometers (μm) can then be used to separate glass, by translating the CO₂ laser-beam along the cutting line. Such a laser-cutting process is described in U.S. Pat. Nos. 9,102,007 and 9,296,066, each thereof commonly owned with the present application, and the complete disclosure of each is incorporated herein by reference for all purposes.

### BRIEF SUMMARY

Laser material-processing requires a precisely-positioned and tightly-controlled focus of the laser beam. Relatively small variances in material properties (such as normal material inhomogeneities) can cause a loss of focus control. Non-planar material surfaces can defocus a laser beam due to refraction, reducing the intensity of the laser beam at the intended focus. It is possible for the beam intensity to be reduced below a threshold for the intended material processing.

Practitioners of skill in the art use “surface quality” as a measure of these variations. “Surface quality” has two contributions: small-scale surface structure, referred to as “surface roughness” or “surface finish;” and large scale structure, referred to as “surface irregularity” or “surface flatness.”

Small-scale surface structure, having high spatial frequency, causes optical losses. Usually these are scattering losses, which reduce the optical power reaching the processing location after a laser beam is transmitted through the surface. This “surface roughness” or “surface finish” is quantified by Rₐ (average deviation from a mean plane of the surface) or R_{RMS} (average maximum peak-valley deviation over a prescribed surface area)

Large-scale surface structure, having low spatial frequency, causes wavefront distortion. By way of example, this wavefront distortion prevents a focused laser beam transmitted through the surface from forming a well-defined focus. This “surface irregularity” or “surface flatness” may be quantified by counting interference fringes of a monochromatic test beam when the surface contacts another known flat surface. Therefore, deviation from an ideal flat surface is measured in multiples of the wavelength λ of the test beam.

Existing solutions do not account for laser processing a workpiece when a laser beam is directed through a surface of the workpiece having low surface quality, leading to loss of focus control.

In one aspect, a method is disclosed for laser processing a workpiece having a workpiece surface. The method includes providing a laser beam having a wavelength at which the workpiece is transparent. A cover is provided and spaced apart from the workpiece surface. The cover has a surface proximal to the workpiece surface and a surface distal to the workpiece surface, where the distal surface has a surface quality better than a surface quality of the workpiece surface. A fluid is provided between and in contact with the proximal surface and the workpiece surface. A laser beam is directed through the cover, through the fluid, and through the workpiece surface.

In one aspect, a laser processing apparatus includes a cover, a fluid dispenser, and a laser system. The cover can be spaced apart from a workpiece's surface and includes a surface proximal to the workpiece surface and a surface distal to the workpiece surface. The distal surface has a surface quality better than a surface quality of the workpiece surface. The fluid dispenser is configured to introduce fluid between and in contact with the proximal surface and the workpiece surface. The laser system is configured to direct a laser beam through the cover, through the fluid, and through the workpiece surface, and the laser beam has a wavelength at which the workpiece is transparent.

### BRIEF DESCRIPTION OF THE DRAWINGS

FIG. 1A is a photograph of a laser processed workpiece having low surface quality. FIG. 1B is a photograph of a laser processed workpiece having low surface quality in accordance with an embodiment of the present invention.

FIG. 2A is a schematic of a laser apparatus processing a workpiece having a high surface quality. FIG. 2B is an enlarged schematic of a portion of FIG. 2A. FIG. 2C is a schematic of a laser apparatus processing a workpiece having a low surface quality.

FIG. 3 is a schematic of a laser apparatus processing a workpiece having a low surface quality in accordance with an embodiment.

FIG. 4 is a schematic of a laser apparatus processing a workpiece having a low surface quality in accordance with an embodiment.

FIG. 5 is a schematic of a laser apparatus processing a workpiece having a low surface quality in accordance with an embodiment.

FIG. 6 is a schematic of a laser apparatus processing a workpiece having a low surface quality in accordance with an embodiment.

FIG. 7 is a laser processing method in accordance with an embodiment.

### DETAILED DESCRIPTION

Methods and apparatuses described herein position a cover and fluid between a laser system and a workpiece surface, with the cover including a distal surface having a surface quality better than a surface quality of the workpiece surface. Embodiments described herein reduce ray scattering due to refraction through a surface having low surface quality, thereby increasing control of the position and size of a laser beam's focus inside or outside a workpiece. They enable formation of a focus with an intended intensity distribution when a converging beam of laser radiation must traverse a surface having low surface quality. Methods and apparatuses described herein may be advantageous where, for example, a workpiece inherently includes low surface quality (e.g., drawn glass or unpolished glass), other processing steps reduce surface quality of a workpiece's surface (e.g., microfabrication of semi-conductor devices), and in any laser process that requires a tightly controlled laser focus.

Herein, “focus” refers to tight foci and to elongated foci, which are both used in laser material-processing. A tight focus can be formed by focusing optics having relatively short focal lengths that cause minimal aberration of the laser beam. An elongated focus can be formed by focusing optics that deliberately cause aberration of the laser beam. By way of example, an elongated focus can be created by filling the clear aperture of a focusing lens having spherical aberration. Alternatively, an aspheric focusing lens may be configured to form an elongated focus having a uniform intensity distribution along the optical axis, as described in U.S. patent application Ser. No. 15/352,385 (U.S. Patent Publication No. 2018/0133837), which is commonly owned with the present application. An elongated focus has advantages in laser-cutting, because the focused laser-radiation is distributed to favor creation of long defects that extend through the full thickness of the workpiece.

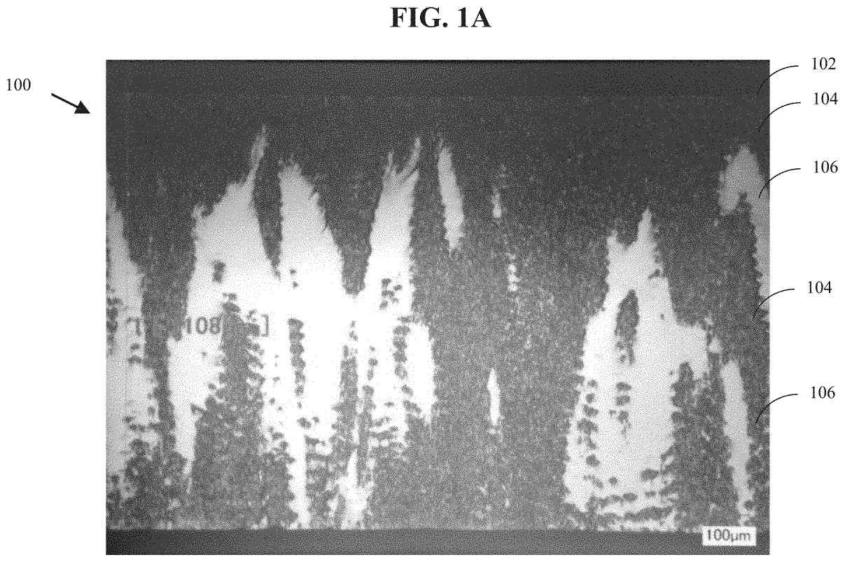

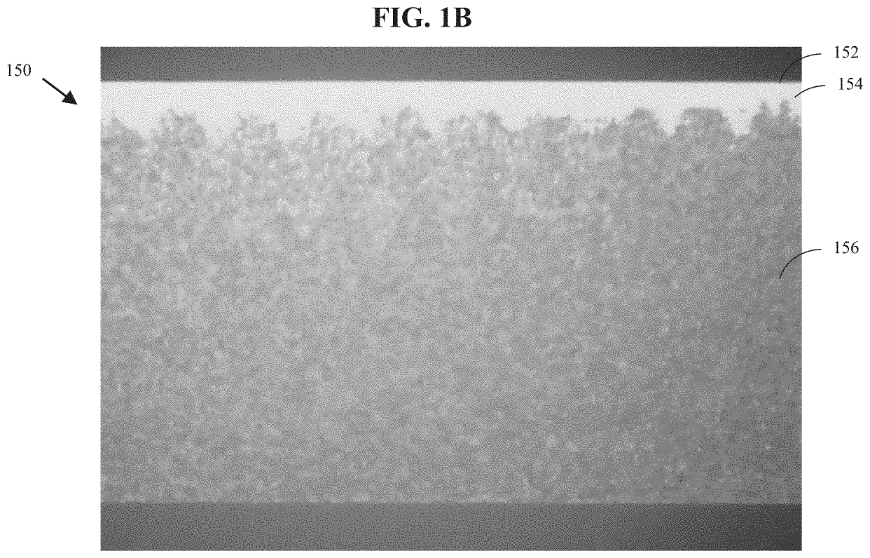

Turning now to the drawings, where like features are designated by like reference numerals, FIG. 1A is a photograph 100 of a side, cross-sectional view of a workpiece having a surface 102 with low surface quality. Photograph 100 depicts a cut edge after laser processing and separation. The workpiece in FIG. 1A was drawn glass manufactured by Corning, Inc. under the brand name Gorilla® Glass. The glass in FIG. 1A measured approximately 1.1 mm thick (from top to bottom, as depicted in photograph 100) and the depicted section measured approximately 1.5 mm wide. A SmartCleave® Optic (sold by Coherent, Inc. of Santa Clara, Calif.) having a nominal focal length of 15 mm was used to focus a pulsed laser beam having bursts of pulses. The SmartCleave® Optic created an elongated focus. Each burst had four pulses and the pulsed laser beam had a wavelength of 1.064 μm. The total burst energy was about 500 μJ. Individual pulses within a burst were separated by 25 ns, corresponding to a pulse repetition rate of 40 MHz. It was intended that each burst would form an extended defect that weakens the material. The defects were intended to be spaced at intervals of 5 μm.

The cross-section in photograph 100 is in a plane traversed by the optical axis of the pulsed laser beam. Dark regions 104 represent areas where the laser beam formed defects that weakened the material. Clear regions 106 represent incomplete or interrupted defects, i.e., where the material was not weakened. As can be seen in photograph 100, unprocessed regions where there are no defects 106 are frequent and irregular. Although the workpiece in FIG. 1A was sufficiently weakened to be separated, the workpiece was prone to chipping because of the frequent regions of unprocessed material, which may cause off-axis fracturing of the workpiece during separation. Further, the inconsistencies in the laser processing made the separation unpredictable, yielding unacceptable variations from cut to cut.

The inventors posited that the low surface quality of surface 102 of the workpiece adversely affected the laser system's (not shown) ability to produce a precisely-positioned and tightly-controlled focus, thereby forming the incomplete or interrupted defects. FIG. 1B is a photograph 150 of a side, cross-sectional view of another workpiece of the same material as the workpiece in FIG. 1A, but processed with herein disclosed embodiments of laser processing apparatuses and methods that reduce the effect of a workpiece's low surface quality. Other than a region 154 in close proximity to surface 152, the workpiece presents primarily processed regions 156, demonstrating that an appropriately controlled focus facilitated the laser processing. This workpiece is more likely to separate cleanly than the workpiece in photograph 100 in FIG. 1A, yielding a more predictable cut with less chips.

The improved results depicted in FIG. 1B may be particularly suitable to workpieces with, for example, surfaces having low surface quality (e.g., drawn glass, workpieces roughened in other processing steps, etc.) and for applications that require highly precise positioning and control of the focus. Although FIGS. 1A and 1B depict processing in a plane, the workpiece may be processed along any straight or curved cutting line by directing the optical axis of the laser beam accordingly.

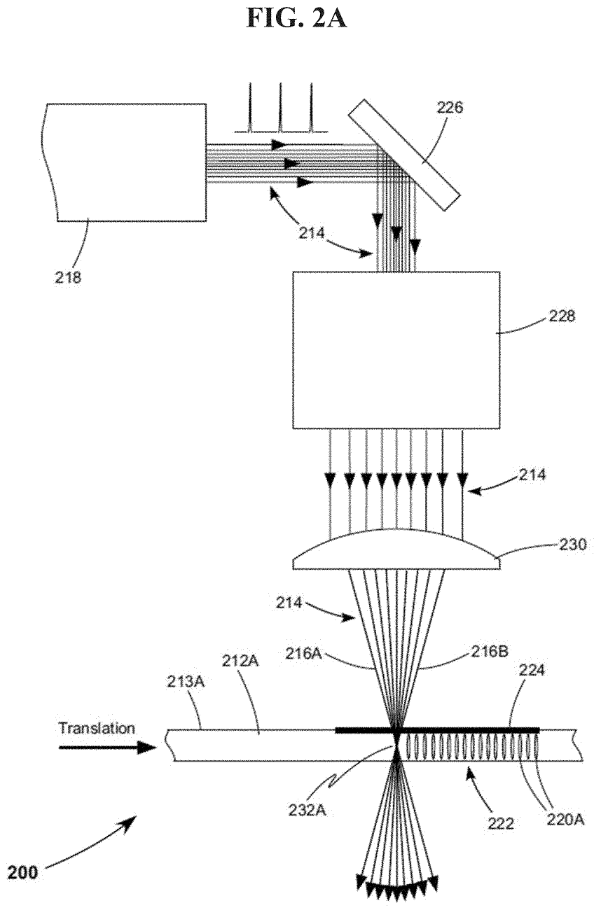

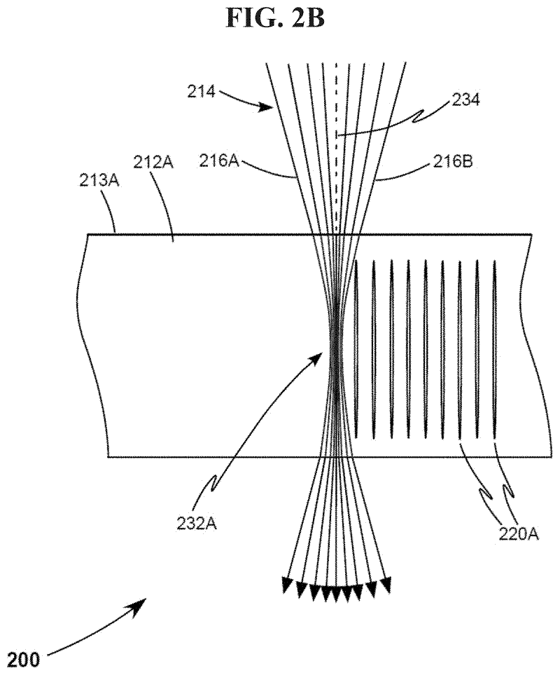

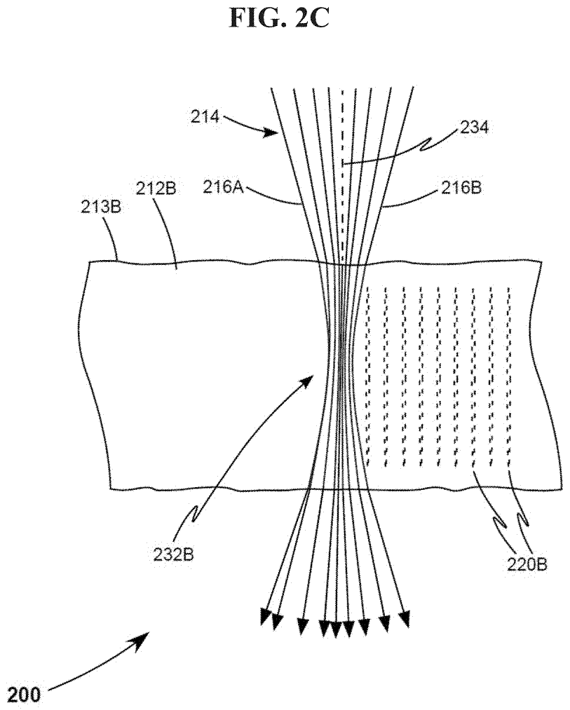

FIG. 2A is a schematic of laser processing apparatus 200. In FIG. 2A, a workpiece 212A with surface 213A is exposed to a focused beam of pulsed laser-radiation 214 from laser processing apparatus 200. Focusing of pulsed laser-radiation 214 is indicated by converging rays 216A and 216B, representing the boundary rays of the focused beam of laser-radiation. Beam of pulsed laser-radiation 214 is generated by a source of pulsed laser-radiation 218 and has a wavelength at which workpiece 212A is transparent. Beam of pulsed laser-radiation 214 is a beam of repeated individual laser-pulses (here, only three shown) or repeated bursts of lasers pulses. Each pulse or each burst of pulses creates a defect 220A in the workpiece. An array 222 of defects 220A is created by translating workpiece 212A laterally with respect to beam of pulsed laser-radiation 214, as indicated by the arrow. The focused beam traces a cutting line 224, which follows the outline of an item to be cut from the workpiece.

Apparatus 200 further includes an optional beam-steering optic 226, an optional beam-conditioning optic 228, and a focusing lens 230. FIG. 2A depicts beam-steering optic 226 as a plane mirror arranged to intercept beam of pulsed laser-radiation 214 from laser-source 218 and direct it towards workpiece 212A. Beam-conditioning optic 228 is depicted as an afocal beam-expander arranged to intercept directed beam of pulsed laser-radiation 214 and expand it to mostly fill focusing lens 230. Focusing lens 230 is depicted as a plano-convex lens that is arranged to intercept expanded beam of pulsed laser-radiation 214 and bring it to focus in workpiece 212A. Other beam-steering optics and beam-conditioning optics could also be used.

Focusing lens 230 could be a single-element lens as depicted or a multi-element lens assembly. Workpiece 212A is depicted being translated with respect to a stationary focused beam of pulsed laser-radiation 214. Alternatively, galvanometer-actuated mirrors could be included in beam-conditioning optic 228 and a flat-field objective lens used for focusing lens 230, thereby enabling focused beam of pulsed laser-radiation 214 to be translated with respect to a stationary workpiece 212A.

FIG. 2B is an enlarged schematic of laser beam 214 interacting with workpiece 212A. In the embodiment of FIG. 2A and FIG. 2B, surface 213A of workpiece 212A has high surface quality. Beam 214 is represented by rays incident on surface 213A and has an optical axis 234 normal to surface 213A. As the rays of beam 214 pass from gas above workpiece 212A into workpiece 212A, a difference in refractive index between the gas and workpiece 212A causes the rays to refract. Because surface 213A of workpiece 212A has high surface quality, each ray refracts by a predictable angle, determined by the ray's incident angle to the surface. Because surface 213A has high quality, the intensity distribution of focus 232A is precise and tightly controlled, resulting in the formation of defects 220A. It should be noted that the gas above workpiece 212A could be ambient air or could be an assist gas or assist gas-mixture selected to improve the laser processing.

FIG. 2C is an enlarged schematic of laser beam 214 interacting with another workpiece 212B. In FIG. 2C, workpiece 212B has surface 213B of low surface quality. Workpiece 212B is exposed to beam of pulsed laser-radiation 214 from apparatus 200. Surface 213B scatters the rays of beam 214 because of unpredictable refraction by the low quality surface. Ray scattering produces an uncontrolled focus. For example, in the case of tight focusing, ray scattering produces a focus having a poorly defined beam waist location and beam waist diameter. In the case of elongated focusing, ray scattering produces a focus having an anomalous intensity distribution along and about optical axis 234. In particular, the scattering reduces the beam intensity at or around intended focus 232B. If the surface quality of surface 213B is too low, the scattering may thereby prevent laser processing.

In laser filament processing, for example, the scattering may reduce the intensity of the laser beam at the intended focus 232B below a threshold for non-linear self-focusing, preventing formation of filaments. When filaments do form, the anomalous intensity distribution along optical axis 234 may lead to the creation of incomplete and irregular defects 220B. Under such conditions, laser filament processing would produce frequent and irregular unprocessed regions, like those shown in photograph 100 of FIG. 1A.

Embodiments disclosed herein can produce the superior laser processing of FIG. 1B for a workpiece with low surface quality (such as surface 213B in FIG. 2C). FIG. 3 is a cross-sectional view of laser processing apparatus 300 processing a workpiece in accordance with such an embodiment. Apparatus 300 includes cover 302, spaced apart from surface 213B of workpiece 212B, and a fluid dispenser (not shown) configured to introduce fluid 306 between and in contact with proximal surface 304B of cover 302 and surface 213B of workpiece 212B. (As used herein, “distal” and “proximal” cover surfaces are located with respect to the workpiece, unless otherwise stated.) A laser system (not shown) directs a laser beam 214 through cover 302, through fluid 306, and into workpiece surface 213B. In some embodiments, the laser processing apparatus includes the laser system described above with respect to FIGS. 2A-2C. In some embodiments, cover 302 is contained within a laser processing apparatus that further includes a laser system and a fluid dispenser configured to introduce fluid 306 between and in contact with cover 302 and a workpiece.

Distal surface 304A of cover 302 has a surface quality better than surface 213B of workpiece 212B. As used herein, a first surface has a better surface quality than a second surface when the first surface's surface roughness is lower than the second surface's surface roughness and/or the first surface's surface irregularity is lower than the second surface's surface irregularity. In some embodiments, distal surface 304A has an optical quality equivalent to a surface having roughness of less than 20 Å (Angstroms) and/or irregularity of less than λ/4, where λ is the wavelength of the laser beam. In some embodiments, distal surface 304A has an optical quality equivalent to roughness of less than 5 Å and/or irregularity of less than λ/20. As used herein, “surface quality” refers to those areas of a workpiece where the laser beam is incident on a surface of the workpiece.

As the rays of beam 214 pass through distal surface 304A, a difference between the refractive indices of the gas and cover 302 causes the rays to refract. Because distal surface 304A of cover 302 has a better surface quality than surface 213B of workpiece 212B, the rays will refract more predictably than if the rays passed through surface 213B depicted in FIG. 2C. This leads to more controlled and predictable foci, which results in more accurate laser processing, such as the cuts shown in FIG. 1B.

Fluid 306 can flow to occupy the troughs of the rough surface of workpiece 212B, resulting in a cover/fluid/workpiece arrangement with distal surface 304A serving as the interface of the gas and the cover/fluid/workpiece arrangement for incident laser beam 214. Fluid 306 is selected such that the difference between the refractive indices of fluid 306 and workpiece 212B is smaller than the difference between the refractive indices of the gas and workpiece 212B. This selection reduces refraction as the laser beam passes through surface 213B, thereby reducing undesirable scattering of the rays. Both cover 302 and fluid 306 are selected to be transparent at the wavelength of laser beam 214. Ray scattering can be further reduced, as explained below.

To minimize reflective losses through the cover/fluid/workpiece arrangement, it is preferable to select a cover that has a refractive index less than or equal to the refractive index of the workpiece. The fluid would be preferably selected to have a refractive index that is between the refractive index of the workpiece and the refractive index of the cover. To further minimize reflective losses, one or both of the proximal and distal surfaces of the cover may have an antireflection coating.

In some embodiments, fluid 306 has a refractive index matching the refractive index of workpiece 212B. As used herein, a refractive index matches another refractive index when they are less than 10% different from one another. In some embodiments, a fluid's refractive index is less than 3% different from a workpiece's refractive index. Matching the refractive indices of fluid 306 and workpiece 212B reduces or eliminates refraction at surface 213B of workpiece 212B. In some embodiments, cover 302 has a refractive index matching the refractive indices of both fluid 306 and workpiece 212B. After passing through distal surface 304A, the rays would pass through cover 302, fluid 306, and workpiece 212B without changing direction due to the constant (or near constant) refractive index.

In some embodiments, the cover's thickness is chosen so that the cover is sufficiently resilient to prevent warping or changes in position. In some embodiments, the cover thickness and fluid thickness are chosen to minimize the distance between the cover's distal surface and the workpiece surface. Minimizing the distance between the cover's distal surface and the workpiece surface maximizes an effective working distance of the laser system. Specifically, here, the working distance between focusing lens 230 (depicted in FIG. 2A) and the cover. Minimizing the distance between the cover's distal surface and the workpiece surface also minimizes the change in depth-of-focus in the workpiece compared to focusing into the workpiece alone, as depicted in FIGS. 2A-2C. In some embodiments, the fluid has a minimum thickness greater that the peak-to-peak roughness of the workpiece.

In some embodiments, cover 302 is made of a glass. In some embodiments, a cover is made of soda lime glass. By way of example, the cover used to capture FIG. 1B was soda lime glass having a thickness of about 300 μm. In some embodiments, the cover is made of fused silica, or any transparent material having the required surface quality. The cover material could be selected to meet any other application requirements, for example, a chemically resistant glass.

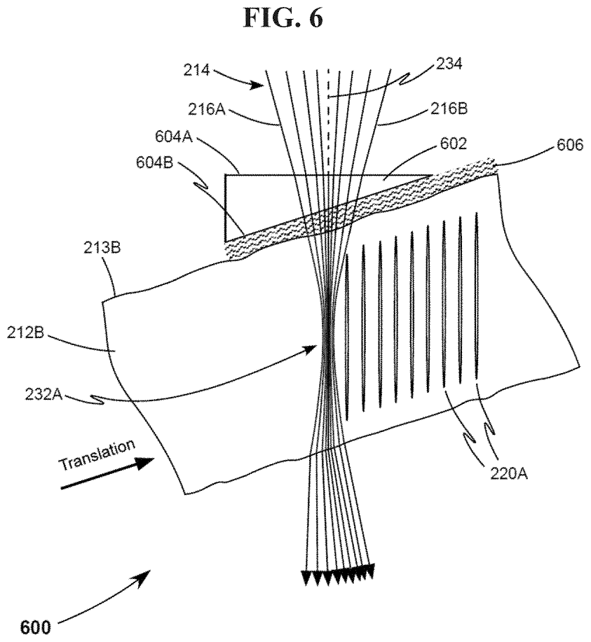

As depicted in FIG. 3, an optical axis 234 of laser beam 214 is incident normally onto surface 213B of workpiece 212B. In some embodiments, an optical axis of a laser beam is incident on a surface of a workpiece at a non-normal angle (for example, see FIG. 6 described below).

As depicted in FIG. 3, distal surface 304A is planar and an optical axis 234 of laser beam 214 is incident normally onto distal surface 304A. In some embodiments, distal surface 304A is non-planar. In some embodiments, optical axis 234 of laser beam 214 is incident onto a distal surface of a cover at a non-normal angle.

As depicted in FIG. 3, distal surface 304A and proximal surface 304B are parallel. As used herein, the term “parallel” is understood to include deviations from perfectly parallel that do not affect an application of the laser beam. For example, a deviation of two surfaces perfectly parallel is within the term “parallel” if the deviation is not so large as to change the focus depth when translating the beam from one side of a workpiece to the other, such that the process would exceed application tolerances. In some embodiments, distal surface 304A and proximal surface 304B are not parallel (for example, see FIG. 6 described below).

As depicted in FIG. 3, proximal surface 304B is parallel to workpiece surface 213B. In some embodiments, proximal surface 304B is not parallel to workpiece surface 213B.

In some embodiments, fluid 306 includes a liquid, a gel, a malleable polymer, or a conformable solid. In some embodiments, fluid 306 is an oil. Exemplary oils to match a workpiece made of Gorilla® Glass having a refractive index of about 1.51 at 1064 nanometers include IM01-immersion oil/IM02-immersion oil (refractive index 1.48-1.482), glycerin (refractive index 1.46), and Olympus immersion oil (refractive index 1.51). In some embodiments, the cover is a transparent foil (e.g., PVC) and the fluid is an adhesive having a refractive index matching a workpiece's refractive index.

In some embodiments, laser beam 214 has a wavelength at which workpiece 212B is transparent. As used herein, an object is “transparent” to a laser beam when all or a portion of the laser beam's power incident on an object's surface is transmitted to a location below the object's surface. For example, an object is transparent to a laser beam when 40% of incident laser power is transmitted to a location below the object's surface or an object is transparent to a laser beam when 70% of incident laser power is transmitted to a location below the object's surface. For example, a workpiece is transparent when at least 40% of incident laser power is transmitted to the location of a focus.

In some embodiments, the laser system is configured to form a focus 232A at a location inside workpiece 212B. In some embodiments, the laser system is configured to direct the laser beam 214 through a second opposite surface of the workpiece and form a focus outside the workpiece. For example, below the lower surface (in the orientation depicted in FIG. 3) of workpiece 212B.

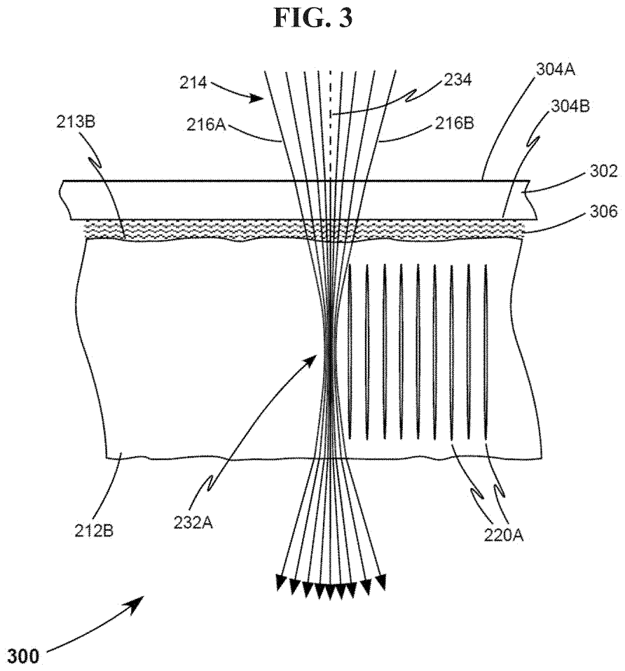

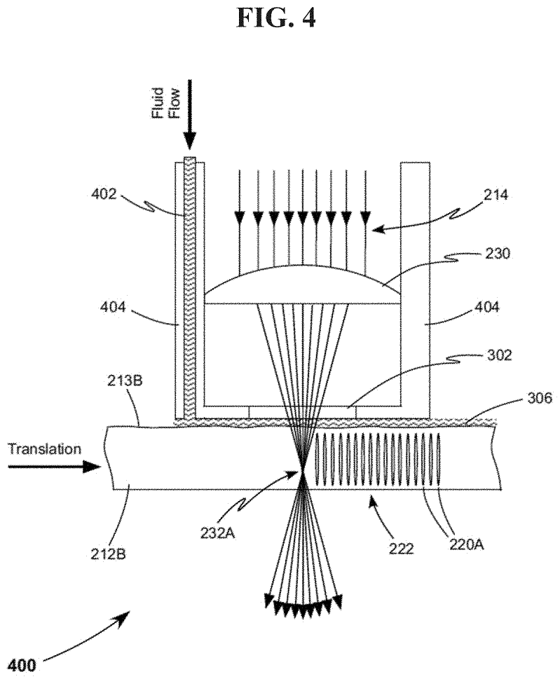

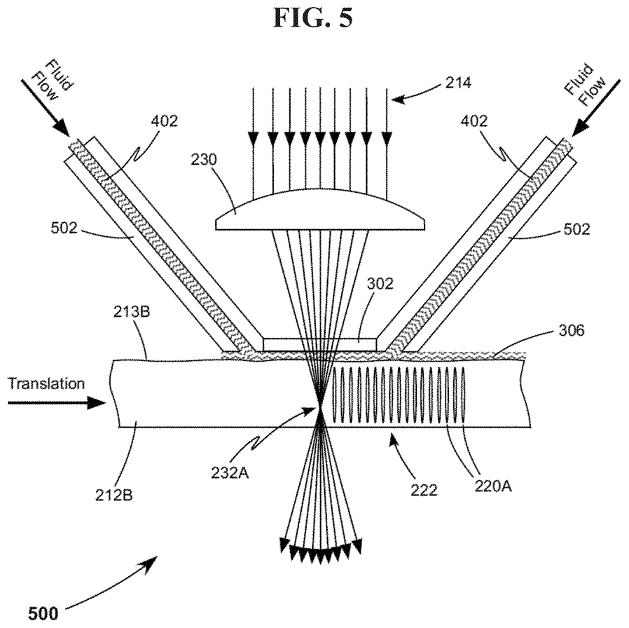

In some embodiments, an apparatus includes a translation stage configured to move the workpiece relative to the laser beam and the fluid dispenser is configured to introduce fluid between the cover and workpiece while the workpiece moves relative to the laser beam (see FIG. 4 and FIG. 5 below).

In some embodiments, the apparatus includes a fluid removal system configured to remove fluid 306 from workpiece 212B after the laser beam 214 has processed workpiece 212B. In such embodiments, a volatile index matched fluid may be used for efficient and complete fluid removal.

In some embodiments, the laser system is configured to focus the laser beam to form a filament and thereby create a defect 220A in workpiece 212B. In some embodiments, laser processing apparatus 300 is used for other laser processes, such as stealth dicing (e.g., processing of silicon at a wavelength of about 1 μm). Laser processing apparatus 300 may be advantageous in, for example, any laser material processing requiring good beam integrity, particularly high intensity and/or fine control of beam parameters.

FIG. 4 is a cross-sectional view of a laser processing apparatus 400 in accordance with an embodiment. Laser processing apparatus 400 includes fluid supply line 402, fluid dispenser 404, cover 302, and a laser system (which includes focusing optic 230). Fluid dispenser 404 receives fluid 306 from a fluid reservoir (not shown) and provides the fluid between and in contact with cover 302 and workpiece 212B.

Laser beam 214 passes through cover 302, through fluid 306, and into workpiece 212B. In the embodiment depicted in FIG. 4, laser beam 214 forms a focus 232A located inside workpiece 212B and forms a defect 220A. Translation of the laser beam with respect to the workpiece creates an array of defects 222 in workpiece 212B. Exemplary systems and methods for laser filament processing are described in described in U.S. Pat. Nos. 9,102,007 and 9,296,066, each thereof commonly owned with the present application, and incorporated herein by reference. Such a laser-cutting process SmartCleave® is licensed by Coherent, Inc.

Fluid dispenser 404 incorporates the cover 302, at least one fluid supply line 402, and at least one fluid reservoir (not shown). The shape of the bottom surface of the dispenser that includes the cover could be round, rectangular, or any shape suitable for the application. In some embodiments, fluid dispenser 404 is either a part of the laser-processing head or is attached to the head. Fluid is dispensed by a pump, capillary action, and/or gravity. For a pump embodiment, the pumps (not shown) may include an adjustable pump speed that is varied in combination with the translation speed (of the workpiece) to create a desired fluid feed between the cover and the workpiece. A fluid film may remain on the workpiece after laser processing. As described above with respect to FIG. 3, a laser processing apparatus may include a fluid removal system.

FIG. 5 is a cross-sectional view of laser processing apparatus 500 in accordance with an embodiment. Laser processing apparatus 500 is similar to laser processing apparatus 400, and the discussion of FIG. 4 applies to FIG. 5, and vice versa. Differences include a fluid dispenser 502 with two fluid lines 402 inclined to the plane of the cover 302, and that fluid dispenser 502 is a separate assembly.

Laser beam 214 passes through cover 302, through fluid 306, and into workpiece 212B. In the embodiment depicted in FIG. 5, laser beam 214 forms a focus 232A located inside workpiece 212B and forms a defect. Translation of the laser beam with respect to the workpiece creates an array of defects 222 in workpiece 212B.

FIG. 6 is a cross-sectional view of laser processing apparatus 600 processing a workpiece in accordance with an embodiment. Laser processing apparatus 600 is similar to laser processing apparatus 300 described above with respect to FIG. 3—that description applies equally to laser processing apparatus 600, and vice versa. The differences between laser processing apparatus 600 and laser processing apparatus 300 include the shape of cover 602 and the angle of inclination of workpiece 212B with respect to laser beam 214.

As shown in FIG. 6, optical axis 234 of laser beam 214 is incident on surface 213B of workpiece 212B at a non-normal angle. In this arrangement, directing the laser beam comprises focusing the laser beam to produce a laser defect in the workpiece that is oblique to the workpiece surface. This embodiment can be used for surfaces with low surface quality (shown) or with high surface quality. It enables an inclined workpiece or an inclined section of a workpiece to be laser processed. In the case of laser filamentation, it would also allow filaments to be formed and defects to be created that are inclined with respect to the surfaces of the workpiece.

Cover 602 includes a distal surface 604A upon which laser beam 214 is incident normally and proximal surface 604B that is parallel to surface 213B of workpiece 212B. Distal surface 604A and proximal surface 604B are thus mutually inclined and cover 602 has a wedge or prism shape. In other embodiments, the cover may have a different shape, provided that the distal and proximal surface of the workpiece are mutually inclined. Again, a fluid 606 is between and in contact with proximal surface 604B and surface 213B. For example, a variety of proximal surface-distal surface relative inclinations (including a parallel arrangement) are available so that a cover can be moved to accommodate a variety of cuts on a workpiece.

FIG. 6 shows relative translation of the workpiece with respect to the prism-shaped cover and focused laser beam. Some embodiments translate the prism-shaped cover and the focused laser beam, while the workpiece is stationary.

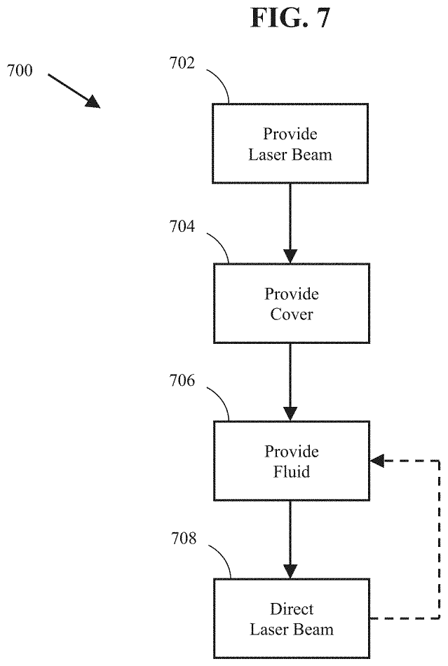

FIG. 7 is a flow diagram of laser processing method 700 in accordance with an embodiment. Method 700 is a method of laser processing a workpiece having a workpiece surface and includes: providing a laser beam 702, where the laser beam has a wavelength at which the workpiece is transparent; providing a cover 704 spaced apart from a workpiece surface, wherein the cover has a surface proximal to the workpiece surface and a surface distal to the workpiece surface, and wherein the distal surface has a surface quality better than a surface quality of the workpiece surface; providing a fluid 706 between and in contact with the proximal surface and the workpiece surface; and directing the laser beam 708 through the cover, through the fluid, and through the workpiece surface. As used herein, “directing the laser beam” is understood to include any movement of the laser beam relative to the workpiece. For example, “directing the laser beam” includes moving a laser system while keeping the workpiece stationary, moving the workpiece while keeping a laser system stationary, or scanning a laser beam laterally with respect to the workpiece. Optionally, method 700 may loop from directing the laser beam 708 to providing a fluid 706, such as, for example, when the workpiece is translated relative to the laser beam.

In some embodiments of the method, directing the laser beam includes focusing the laser beam and forming a defect in the workpiece.

In some embodiments, the fluid has a refractive index that is between a refractive index of a gas above the cover and a refractive index of the workpiece. In some embodiments, the fluid has a refractive index that is between a refractive index of the cover and a refractive index of the workpiece. In some embodiments of the method, the fluid has a refractive index matching the refractive index of the workpiece.

In some embodiments of the method, the distal surface has a lower surface roughness than a surface roughness of the workpiece surface. In some embodiments of the method, the distal surface has a surface roughness of less than 20 Å.

In some embodiments of the method, the distal surface has a lower surface irregularity than a surface irregularity of the workpiece surface. In some embodiments of the method, the laser beam has a wavelength λ and the distal surface has a surface irregularity of less than λ/4.

In some embodiments of the method, the proximal surface is parallel to the workpiece surface.

In some embodiments of the method, an optical axis of the laser beam is incident normally onto the workpiece surface.

In some embodiments of the method, wherein an optical axis of the laser beam is incident onto the workpiece surface at a non-normal angle.

In some embodiments of the method, the proximal surface and distal surface are parallel. In some embodiments of the method, the proximal surface and distal surface are mutually inclined. In some embodiments of the method, the proximal surface is parallel to the workpiece surface, and directing the laser beam comprises focusing the laser beam to produce a defect in the workpiece and oblique to the workpiece surface.

In some embodiments of the method, the distal surface has a convex shape.

In some embodiments of the method, the cover is glass. In some embodiments of the method, the fluid is an oil. In some embodiments of the method, the cover is a foil and the fluid is an adhesive having a refractive index matching a refractive index of the workpiece.

In some embodiments of the method, directing the laser beam comprises focusing the laser beam at a location inside the workpiece. In some embodiments of the method, directing the laser beam further comprises directing the laser beam through a second surface of the workpiece and focusing the laser beam at a location outside the workpiece.

Some embodiments of the method further comprise repeatedly directing the laser beam while moving the workpiece relative to the laser beam and adding fluid between the proximal surface and workpiece surface.

Some embodiments of the method further comprise removing the fluid after the directing the laser beam.

In some embodiments, focused beam of pulsed laser-radiation 214 converges to a focus that is elongated along optical axis 234, as discussed above. Referring to FIGS. 2A and 2B, rays close to optical axis 234 converge closer to or further from focusing lens 230 than boundary rays 216A and 216B, thereby extending the focus along the optical axis. Workpiece 230 would be located such that the elongated focus overlaps or at least partially overlaps with the workpiece. Defects 220A are depicted extending through most of the thickness of workpiece 213A. For cutting applications, in particular, it is preferable for the defects to extend through the full thickness of the workpiece. In general, the length of an elongated focus defines the length of the defects, provided each burst of pulses has sufficient energy.

In some embodiments, the cover surfaces may be non-planar. Although cover 302 is depicted in FIGS. 3-5 as a sheet and cover 602 is depicted in FIG. 6 as a prism, the cover may have a plano-convex shape such that each ray is incident normally on the cover's distal surface 304A. In accordance with the present invention, a distal surface 304A having a convex shape would have a higher surface quality than surface 213B of workpiece 212B. This plano-convex shape may be advantageous when, for example, a workpiece has a high refractive index, to minimize reflective losses through the cover/fluid/workpiece arrangement.

As discussed herein above, in some embodiments, the laser processing apparatus is configured to direct laser beam 214 through surface 213B and through a second opposite surface of workpiece 212B. In these embodiments, a second cover may be spaced apart from the second surface, and having a fluid filling the space thereinbetweeen. This arrangement allows a focus to be formed outside a workpiece with opposing surfaces that both have low surface quality. An external focus is favorable in some applications. For example, to form a defect that extends to a surface may require an elongated focus that traverses the surface.

Some embodiments include an additional step of exposing a workpiece to a beam of laser-radiation generated by a source of laser-radiation different from laser-source 218 of FIG. 2A. The beam of laser-radiation from a different source may have a wavelength that is absorbed by the workpiece 212. The workpiece may be translated laterally with respect to the beam of different laser-radiation and the beam heats the material weakened by defects 220A, causing it to crack completely and creating a cut-edge. Exposing a workpiece to a beam from a second source of laser radiation causing a workpiece to crack is described in more detail in U.S. application Ser. No. 15/913,457, incorporated by reference herein in its entirety for all purposes.

The present invention is described above with reference to preferred and other embodiments. The invention is not limited, however, to the embodiments described and depicted herein. Rather, the invention is limited only by the claims appended hereto. The use herein of “including,” “comprising,” “having,” “containing,” “involving,” and variations thereof is meant to encompass the items listed thereafter and equivalents thereof as well as additional items.

What is claimed is:

1. A method of laser processing a workpiece having a workpiece surface, the method comprising:
providing a laser beam, wherein the laser beam has a wavelength at which the workpiece is transparent;
providing a cover spaced apart from the workpiece surface, wherein the cover has a surface proximal to the workpiece surface and a surface distal to the workpiece surface, and wherein the distal surface of the cover has a surface quality better than a surface quality of the workpiece surface;
providing a fluid between and in contact with the proximal surface of the cover and the workpiece surface; and
directing the laser beam through the cover, through the fluid, and through the workpiece surface.

2. The method of claim 1, wherein directing the laser beam comprises focusing the laser beam and forming a defect in the workpiece.

3. The method of claim 1, wherein the fluid has a refractive index matching the refractive index of the workpiece.

4. The method of claim 1, wherein the fluid has a refractive index that is between a refractive index of the workpiece and a refractive index of the cover.

5. The method of claim 1, wherein the distal surface of the cover has a lower surface roughness than a surface roughness of the workpiece surface.

6. The method of claim 5, wherein the distal surface of the cover has a surface roughness of less than 20 Angstroms.

7. The method of claim 1, wherein the distal surface of the cover has a lower surface irregularity than a surface irregularity of the workpiece surface.

8. The method of claim 7, wherein the laser beam has a wavelength λ and wherein the distal surface of the cover has a surface irregularity of less than λ/4.

9. The method of claim 1, wherein the proximal surface of the cover is parallel to the workpiece surface.

10. The method of claim 1, wherein an optical axis of the laser beam is incident normally onto the workpiece surface.

11. The method of claim 1, wherein an optical axis of the laser beam is incident onto the workpiece surface at a non-normal angle.

12. The method of claim 1, wherein the proximal surface and distal surface of the cover are parallel.

13. The method of claim 1, wherein the proximal surface and distal surface of the cover are mutually inclined.

14. The method of claim 13, with the proximal surface of the cover being parallel to the workpiece surface, and wherein directing the laser beam comprises focusing the laser beam to form a defect in the workpiece and oblique to the workpiece surface.

15. The method of claim 1, wherein the distal surface of the cover has a convex shape.

16. The method of claim 1, wherein the cover is made of glass.

17. The method of claim 1, with the fluid being an oil.

18. The method of claim 1, with the cover being a foil and the fluid being an adhesive having a refractive index matching a refractive index of the workpiece.

19. The method of claim 1, wherein directing the laser beam comprises focusing the laser beam at a location inside the workpiece.

20. The method of claim 1, wherein directing the laser beam further comprises directing the laser beam through a second surface of the workpiece and focusing the laser beam at a location outside the workpiece.

21. The method of claim 1, further comprising repeating the directing the laser beam while moving the workpiece relative to the laser beam and adding fluid between the proximal surface of the cover and workpiece surface.

22. The method of claim 1, further comprising removing the fluid after the directing the laser beam.

23. A laser processing apparatus comprising:
a cover, spaced apart from a workpiece surface, having a surface proximal to the workpiece surface and a surface distal to the workpiece surface, wherein the distal surface of the cover has a surface quality better than a surface quality of the workpiece surface;
a fluid dispenser configured to introduce fluid between and in contact with the proximal surface of the cover and the workpiece surface; and
a laser system configured to direct a laser beam through the cover, through the fluid, and through the workpiece surface, wherein the laser beam has a wavelength at which the workpiece is transparent.

24. The apparatus of claim 23, wherein the laser beam is further configured to focus the laser beam and form a defect in the workpiece.

25. The apparatus of claim 23, wherein the fluid has a refractive index matching a refractive index of the workpiece.

26. The apparatus of claim 23, wherein the fluid has a refractive index between a refractive index of the workpiece and a refractive index of the cover.

27. The apparatus of claim 23, wherein the distal surface of the cover has a lower surface roughness than a surface roughness of the workpiece surface.

28. The apparatus of claim 27, wherein the distal surface of the cover has a surface roughness of less than 20 Angstroms.

29. The apparatus of claim 23, wherein the distal surface of the cover has a lower surface irregularity than a surface irregularity of the workpiece surface.

30. The apparatus of claim 29, wherein the laser beam has a wavelength λ and wherein the distal surface has a surface irregularity of less than λ/4.

31. The apparatus of claim 23, wherein the proximal surface of the cover is parallel to the workpiece surface.

32. The apparatus of claim 23, wherein an optical axis of the laser beam is incident normally onto the workpiece surface.

33. The apparatus of claim 23, wherein an optical axis of the laser beam is incident onto the workpiece surface at a non-normal angle.

34. The apparatus of claim 23, wherein the proximal surface and distal surface of the cover are parallel.

35. The apparatus of claim 23, wherein the proximal surface and distal surface of the cover are mutually inclined.

36. The apparatus of claim 35, with the proximal surface of the cover being parallel to the workpiece surface, and wherein the laser system is configured to form a defect in the workpiece and oblique to the workpiece's surface

37. The apparatus of claim 23, wherein the distal surface of the cover has a convex shape.

38. The apparatus of claim 23, wherein the cover is made of glass.

39. The apparatus of claim 23, with the fluid being an oil.

40. The apparatus of claim 23, with the cover being a foil and the fluid being an adhesive having a refractive index matching a refractive index of the workpiece.

41. The apparatus of claim 23, wherein the laser system is configured to focus the laser beam at a location inside the workpiece.

42. The apparatus of claim 23, wherein the laser system is configured to direct the laser beam through a second surface of the workpiece and focus the laser beam at a location outside the workpiece.

43. The apparatus of claim 23, further comprising a translation stage, and wherein the laser system is configured to repeatedly direct the laser beam through the fluid and through the workpiece surface while the translation stage translates the workpiece relative to the laser beam and fluid is added between the proximal surface of the cover and workpiece surface.

44. The apparatus of claim 23, further comprising a fluid removal system configured to remove the fluid from the workpiece after the laser beam is directed through the fluid and through the workpiece surface.
